(19) United States
(12) Patent Application Publication
(10) Pub. No.: US 2026/0110314 A1
(43) Pub. Date: Apr. 23, 2026

(54) DETACHABLE MOVING SNAP-FIT FASTENER

(71) Applicant: SHENZHEN GREPOW BATTERY CO., LTD, Guangdong (CN)

(72) Inventors: Bing LIU, Guangdong (CN); Shiyu LIU, Guangdong (CN); Su LIU, Guangdong (CN); Gang LI, Guangdong (CN); Li LIN, Guangdong (CN); Shixing ZHAO, Guangdong (CN); Bing GUO, Guangdong (CN)

(21) Appl. No.: 19/110,979

(22) PCT Filed: Feb. 10, 2023
(86) PCT No.: PCT/CN2023/075439

§ 371 Date: Dec. 30, 2025

(30) Foreign Application Priority Data
Sep. 15, 2022 (CN) 202222452270.9

(51) Int. Cl. F16B 1/00

(52) U.S. Cl. CPC F16B 1/00

(57) ABSTRACT

A detachable moving snap-fit fastener, comprising: a housing (1); a snap-fit fastener assembly (2), which is arranged in the housing and is at least partially arranged outside the housing to be snap-fitted with the outside; and a rotating member, which is movably connected to the housing and at least partially extends to the snap-fit fastener assembly, wherein the rotating member rotates to drive at least part of the snap-fit fastener assembly to extend out of or retract into the housing.

### TECHNICAL FIELD

The present disclosure relates to the technical field of snap-fit accessories, and in particular to a detachable movable snap-fit fastener.

### BACKGROUND OF THE INVENTION

A snap-fit fastener is a mechanism used for embedded connection or overall locking between one part and another part, and is usually used for connecting plastic parts and made of a plastic material with certain flexibility.

Most of detachable snap-fit fasteners of the prior art have a snap-lock mechanism, a threaded fastening mechanism or a sliding snap-fit piece mechanism. However, they are inconvenient and costly for users, and occupy large space, such that efficiency of operating and using is low, and tools or accessories are needed to complete opening and assembly operations.

### BRIEF SUMMARY OF THE INVENTION

In view of the above defects in the prior art, the present disclosure provides a detachable movable snap-fit fastener to solve the technical problems mentioned in the above Background.

In order to solve the above technical problems, the present disclosure provides the following technical solution: a detachable movable snap-fit fastener, including: a housing, configured for mounting and supporting components; a snap-fit assembly, where the snap-fit assembly is arranged in the housing, and at least a portion of the snap-fit assembly extends outside the housing to be snap-fitted with an external component; and a rotating member, where the rotating member is movably connected to the housing, at least a portion of the rotating member extends to the snap-fit assembly, and the rotating member rotates to drive at least a portion of the snap-fit assembly to extend out of or retract into the housing.

Further, either side of the rotating member is connected to a rotating shaft, and the rotating member is connected to the housing through the rotating shafts.

Further, the snap-fit assembly includes a left snap-fit assembly and a right snap-fit assembly, the left snap-fit assembly is mounted on a left side inside the housing, and the right snap-fit assembly is mounted on a right side inside the housing.

Further, the left snap-fit assembly includes a left snap-fit bracket, a left snap-fit piece that is snap-fitted onto the left snap-fit bracket, a first elastic member arranged between the left snap-fit piece and the left snap-fit bracket, and a portion of the left snap-fit piece, through the first elastic member, is arranged outside the housing.

Further, the right snap-fit assembly includes a right snap-fit bracket, a right snap-fit piece that is snap-fitted onto the right snap-fit bracket, a second elastic member arranged between the right snap-fit piece and the right snap-fit bracket, and a portion of the right snap-fit piece, through the second elastic member, is arranged outside the housing.

Further, a first wedge block and a second wedge block are respectively arranged on both sides of the rotating member, the left snap-fit bracket is provided with a left channel fitted with the first wedge block, the right snap-fit bracket is provided with a right channel fitted with the second wedge block, and the first wedge block and the second wedge block are respectively arranged in the left channel and the right channel.

Further, the left snap-fit bracket is provided with a first support portion for supporting the rotating shaft, and the right snap-fit bracket is provided with a second support portion for supporting the rotating shaft.

Further, a protruding left guide shaft is arranged on a side surface of the left snap-fit piece, the left snap-fit bracket is provided with a left guide hole fitted with the left guide shaft, a protruding right guide shaft is arranged on a side surface of the right snap-fit piece, and the right snap-fit bracket is provided with a right guide hole fitted with the right guide shaft.

Compared with the prior art, the present disclosure has the beneficial effects as follows: the detachable movable snap-fit fastener mainly includes the housing, the snap-fit assembly and the rotating member. The rotating member is used to control engagement or disengagement of the snap-fit assembly, which simplifies a process of assembly and disassembly.

### BRIEF DESCRIPTION OF THE DRAWINGS

FIG. 1 is a structural schematic diagram of a detachable movable snap-fit fastener in an example.

FIG. 2 is a schematic diagram of an exploded structure of a detachable movable snap-fit fastener in an example.

FIG. 3 is a schematic diagram of an exploded structure of a snap-fit assembly in an example.

FIG. 4 is a structural schematic diagram of a rotating member.

FIG. 5 is a schematic diagram of a partial structure of a left snap-fit assembly.

FIG. 6 is a schematic diagram of a partial structure of a right snap-fit assembly.

Reference numerals in the figures: 1. housing; 2. snap-fit assembly; 3. rotating member; 4. rotating shaft; 5. left snap-fit assembly; 6. right snap-fit assembly; 7. left snap-fit bracket; 8. left snap-fit piece; 9. first elastic member; 10. right snap-fit bracket; 11. right snap-fit piece; 12. second elastic member; 13. first wedge block; 14. second wedge block; 15. left channel; 16. right channel; 17. first support portion; 18. second support portion; 19. left guide shaft; 20. left guide hole; 21. right guide shaft; and 22. right guide hole.

### DETAILED DESCRIPTION OF THE INVENTION

The present disclosure will be further described in detail below with reference to the accompanying drawings.

The examples described with reference to the accompanying drawings are exemplary and only intended to explain the present disclosure, instead of being construed as limiting the present disclosure. In the description of the present disclosure, it should be understood that the terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, etc. indicate azimuthal or positional relations based on those shown in the accompanying drawings only for ease of description of the present disclosure and for simplicity of description, and are not intended to indicate or imply that the referenced device or element must have a particular orientation and be constructed and operative in a particular orientation, and thus may not be interpreted as a limitation on the present disclosure. Furthermore, the terms “first” and “second” are merely for the purpose of description, and cannot be construed as indicating or implying relative importance or implicitly specifying the number of technical features indicated. Thus, a feature defined with “first” and “second” may explicitly or implicitly include one or more of the features. In the description of the present disclosure, “several” and “a plurality of” mean two or more, unless expressly specified otherwise. In the present disclosure, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements. For those of ordinary skill in the art, the specific meanings of the above terms in the present disclosure may be understood according to specific circumstances. In the present disclosure, unless otherwise expressly stated and defined, a first feature being “above” or “below” a second feature may include the first and second features being in direct contact or that the first and second features being not in direct contact but being in contact by means of additional features between the first and second features. In addition, the first feature being “over”, “above” and “on the top of” the second feature includes that the first feature is over and above the second feature, or simply means that the level of the first feature is higher than that of the second feature. The first feature being “under”, “below” and “at the bottom of” the second feature includes that the first feature is over and above the second feature, or simply means that the level of the first feature is lower than that of the second feature.

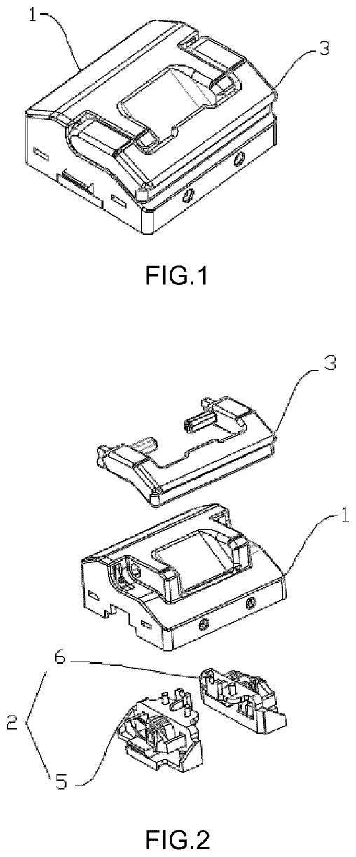

To solve the technical problems described in the Background, as illustrated in FIGS. 1-2, a detachable movable snap-fit fastener is provided. The snap-fit fastener includes: a housing 1, configured for mounting and supporting components; a snap-fit assembly 2, where the snap-fit assembly 2 is arranged in the housing 1, at least a portion of the snap-fit assembly 2 extends outside the housing 1 to be snap-fitted with an external component; and a rotating member 3, where the rotating member 3 is movably connected to the housing 1, at least a portion of the rotating member 3 extends to the snap-fit assembly 2, and the rotating member 3 rotates to drive at least a portion of the snap-fit assembly 2 to extend out of or retract into the housing 1.

The detachable movable snap-fit fastener mainly includes the housing 1, the snap-fit assembly 2 and the rotating member 3. During use, rotation of the rotating member 3 drives the snap-fit assembly 2, such that a snap-fit position on the snap-fit assembly 2 extends or retracts, so as to achieve engagement or disengagement with an external component.

In specific use, when the rotating member 3 rotates, the snap-fit assembly 2 is actuated under the action of the rotating member 3, and the snap-fit position on the snap-fit assembly 2 retracts into the housing 1 and is moved to an external product position; and when the rotating member 3 rotates to reset, the snap-fit assembly 2 is actuated under the action of the rotating member 3, and the snap-fit position on the snap-fit assembly 2 extends out of the housing 1 and is snap-fitted with the external component.

As illustrated in FIG. 4, either side of the rotating member 3 is connected to a rotating shaft 4, and the rotating member 3 is connected to the housing 1 through the rotating shafts 4.

Either side of the rotating member 3 is connected to the rotating shaft 4, and the rotating shaft 4 can be a rotating shaft 4 with a damping effect, such that rotation is more orderly. The rotating member 3 has a U-shaped structure and is hingedly connected to the housing 1 through the rotating shafts 4.

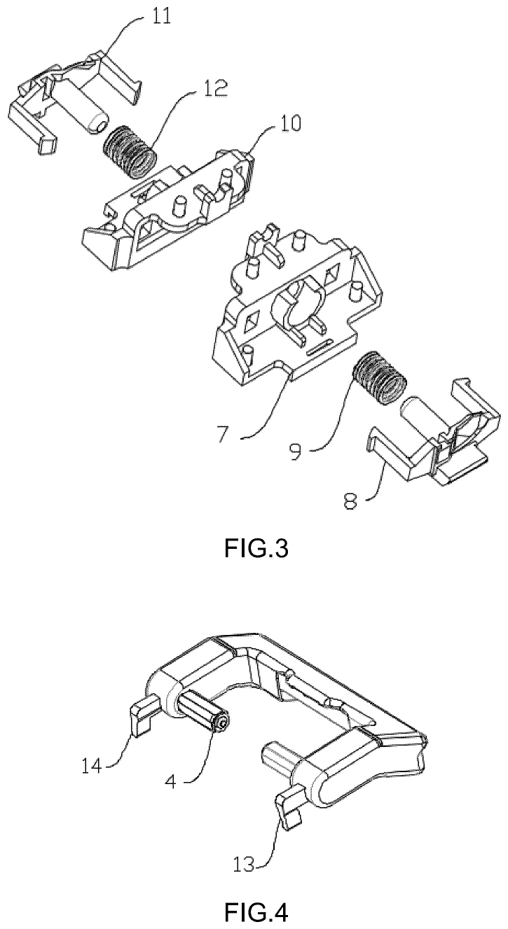

With reference to FIGS. 2-3, the snap-fit assembly 2 includes a left snap-fit assembly 5 and a right snap-fit assembly 6, where the left snap-fit assembly 5 is mounted on a left side inside the housing 1, and the right snap-fit assembly 6 is mounted on a right side inside the housing 1.

In order to improve a snap-fit effect, one or two snap-fit assemblies 2 can be arranged. In this example, two snap-fit assemblies, i.e., the left snap-fit assembly 5 and the right snap-fit assembly 6, are used, where the left snap-fit assembly 5 and the right snap-fit assembly 6 are respectively arranged in the housing 1. Further, the rotating member 3 extends to positions of the left snap-fit assembly 5 and the right snap-fit assembly 6 respectively, such that the snap-fit pieces on the left snap-fit assembly 5 and the right snap-fit assembly 6, under the rotation action of the rotating member 3, extend out of or retract into the housing 1 respectively.

With reference to FIG. 3, the left snap-fit assembly 5 includes a left snap-fit bracket 7, a left snap-fit piece 8 that is snap-fitted onto the left snap-fit bracket 7, and a first elastic member 9 arranged between the left snap-fit piece 8 and the left snap-fit bracket 7, where a portion of the left snap-fit piece 8, through the first elastic member 9, is arranged outside the housing 1.

The above is an implementable technical solution of the left snap-fit assembly 5. The left snap-fit bracket 7 and the left snap-fit piece 8 are snap-fitted with each other, e.g., a pair of snap-fit columns can be arranged on the left snap-fit piece 8 to snap-fit the left snap-fit bracket 7, and the first elastic member 9 is arranged to maintain an elastic state of the left snap-fit piece 8. The first elastic member 9 can exist in the form of a spring. Under the action of the rotating member 3, the left snap-fit piece 8 is forced to compress the first elastic member 9, thereby changing a position of the left snap-fit piece 8, such that a snap-fit piece on the left snap-fit piece 8 extends out of or retracts into the housing 1.

With reference to FIG. 3, the right snap-fit assembly 6 includes a right snap-fit bracket 10, a right snap-fit piece 11 that is snap-fitted onto the right snap-fit bracket 10, and a second elastic member 12 arranged between the right snap-fit piece 11 and the right snap-fit bracket 10, where a portion of the right snap-fit piece 11, through the second elastic member 12, is arranged outside the housing 1.

The right snap-fit assembly 6 is the same as the left snap-fit assembly 5 in structural composition, that is, a same structure is adopted. For example, during use, the rotating member 3 drives the right snap-fit piece 11 to compresses the second elastic member 12, such that a snap-fit piece on the right snap-fit piece 11 extends out of or retracts into the housing 1.

As illustrated in FIG. 4, a first wedge block 13 and a second wedge block 14 are respectively arranged on both sides of the rotating member 3, the left snap-fit bracket 7 is provided with a left channel 15 fitted with the first wedge block 13, and the right snap-fit bracket 10 is provided with a right channel 16 fitted with the second wedge block 14, where the first wedge block 13 and the second wedge block 14 are respectively arranged in the left channel 15 and the right channel 16.

In implementation, a method of driving connection of the rotating member 3 with the left snap-fit assembly 5 and the right snap-fit assembly 6 is provided above. Specifically, the first wedge block 13 and the second wedge block 14 are arranged on the rotating member 3. Further, slots are formed in the housing 1 so that the first wedge block 13 and the second wedge block 14 can pass through respectively. The left channel 15 and the right channel 16 are designed on the left snap-fit bracket 7 and the right snap-fit bracket 10 respectively. In use, the first wedge block 13 is arranged on the left channel 15, and when the rotating member 3 rotates, the first wedge block 13 and the second wedge block 14 slide on the left channel 15 and the right channel 16 respectively. The left channel 15 and the right channel 16 are designed to have a certain slope, such that the left snap-fit piece 8 and the right snap-fit piece 11 are squeezed, and the snap-fit pieces on the left snap-fit piece 8 and the right snap-fit piece 11 can extend out of or retract into the housing 1. Further, when the rotating member 3 rotates to a 90° position, the snap-fit positions of the left snap-fit piece 8 and the right snap-fit piece 11 completely retract into the housing 1.

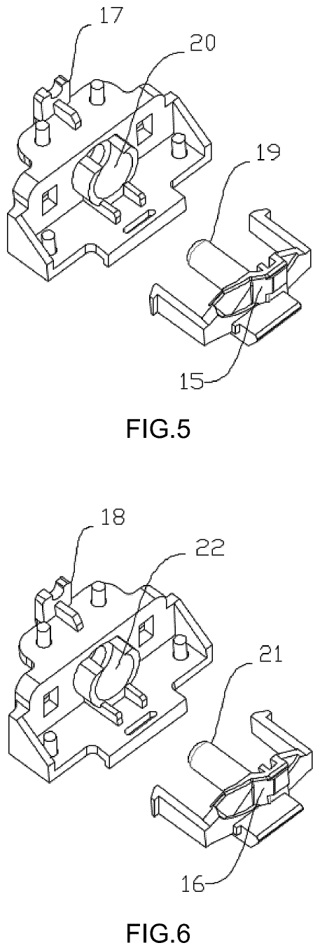

Further, as illustrated in FIGS. 5-6, the left snap-fit bracket 7 is provided with a first support portion 17 for supporting the rotating shaft 4, and the right snap-fit bracket 10 is provided with a second support portion 18 for supporting the rotating shaft 4.

The first support portion 17 and the second support portion 18 are arranged to respectively support the rotating shafts 4 to prevent the rotating shafts 4 from loosening inward.

A protruding left guide shaft 19 is arranged on a side surface of the left snap-fit piece 8, the left snap-fit bracket 7 is provided with a left guide hole 20 fitted with the left guide shaft 19, a protruding right guide shaft 21 is arranged on a side surface of the right snap-fit piece 11, and the right snap-fit bracket 10 is provided with a right guide hole 22 fitted with the right guide shaft 21.

In order to stabilize movement of the rotating member 3 when the left snap-fit piece 8 and the right snap-fit piece 11 are compressed, the left guide shaft 19 and the right guide shaft 21 are added, and can move along the left guide hole 20 and the right guide Hole 22 during a process of extending or retracting.

The foregoing descriptions are not intended to limit the technical scope of the present disclosure. Therefore, any alteration, equivalent change and modification which are made to the above embodiments in accordance with the technical essence of the present disclosure all fall within the scope of protection of the technical solution of the present disclosure.

1. A detachable movable snap-fit fastener, comprising:
a housing, being configured for mounting and supporting components;
a snap-fit assembly, wherein the snap-fit assembly is arranged in the housing, and at least a portion of the snap-fit assembly extends outside the housing to be snap-fitted with an external component; and
a rotating member, wherein the rotating member is movably connected to the housing, at least a portion of the rotating member extends to the snap-fit assembly, and the rotating member rotates to drive at least a portion of the snap-fit assembly to extend out of or retract into the housing.

2. The detachable movable snap-fit fastener according to claim 1, wherein either side of the rotating member is connected to a rotating shaft, and the rotating member is connected to the housing through the rotating shafts.

3. The detachable movable snap-fit fastener according to claim 2, wherein the snap-fit assembly comprises a left snap-fit assembly and a right snap-fit assembly, the left snap-fit assembly is mounted on a left side inside the housing, and the right snap-fit assembly is mounted on a right side inside the housing.

4. The detachable movable snap-fit fastener according to claim 3, wherein the left snap-fit assembly comprises a left snap-fit bracket, a left snap-fit piece that is snap-fitted onto the left snap-fit bracket, a first elastic member arranged between the left snap-fit piece and the left snap-fit bracket, and a portion of the left snap-fit piece, through the first elastic member, is arranged outside the housing.

5. The detachable movable snap-fit fastener according to claim 4, wherein the right snap-fit assembly comprises a right snap-fit bracket, a right snap-fit piece that is snap-fitted onto the right snap-fit bracket, a second elastic member arranged between the right snap-fit piece and the right snap-fit bracket, and a portion of the right snap-fit piece, through the second elastic member, is arranged outside the housing.

6. The detachable movable snap-fit fastener according to claim 5, wherein a first wedge block and a second wedge block are respectively arranged on both sides of the rotating member, the left snap-fit bracket is provided with a left channel fitted with the first wedge block, the right snap-fit bracket is provided with a right channel fitted with the second wedge block, and the first wedge block and the second wedge block are respectively arranged in the left channel and the right channel.

7. The detachable movable snap-fit fastener according to claim 6, wherein the left snap-fit bracket is provided with a first support portion for supporting the rotating shaft, and the right snap-fit bracket is provided with a second support portion for supporting the rotating shaft.

8. The detachable movable snap-fit fastener according to claim 7, wherein a protruding left guide shaft is arranged on a side surface of the left snap-fit piece, the left snap-fit bracket is provided with a left guide hole fitted with the left guide shaft, a protruding right guide shaft is arranged on a side surface of the right snap-fit piece, and the right snap-fit bracket is provided with a right guide hole fitted with the right guide shaft.
